(19) United States
(12) Patent Application Publication
(10) Pub. No.: US 2024/0087219 A1
(43) Pub. Date: Mar. 14, 2024

(54) METHOD AND APPARATUS FOR GENERATING LIGHTING IMAGE, DEVICE, AND MEDIUM

(71) Applicant: Beijing Bytedance Network Technology Co., Ltd., Beijing (CN)

(72) Inventor: Beixin HU, Beijing (CN)

(21) Appl. No.: 18/275,778

(22) PCT Filed: Jan. 24, 2022
(86) PCT No.: PCT/CN2022/073520

§ 371 Date: Aug. 3, 2023

(30) Foreign Application Priority Data
Feb. 7, 2021 (CN) 202110169601.5

(51) Int. Cl. G06T 15/50; A63F 13/57; G06T 7/50; G06T 7/73; G06T 19/20

(52) U.S. Cl. CPC G06T 15/506; A63F 13/57; G06T 7/50; G06T 7/73; G06T 19/20; G06T 2207/10024; G06T 2207/10028; G06T 2210/62; G06T 2219/2004; G06T 2219/2012

(57) ABSTRACT

Provided are a method and apparatus for generating a lighting image, a device, and a medium. The method includes: establishing a plurality of Graphics Processing Unit (GPU) particles in a virtual space; acquiring a position of each GPU particle in the virtual space, and drawing, at the position of each GPU particle, a particle model for representing a lighting area; selecting a plurality of target particle models based on a positional relationship between each particle model and an illuminated object in the virtual space, and determining a lighting range corresponding to each target particle model; rendering each target particle model according to the lighting range corresponding to each target particle model to obtain a virtual lighting range image; and fusing the virtual lighting range image with a scene image corresponding to the illuminated object to obtain a lighting image in the virtual space.

### CROSS REFERENCE TO RELATED APPLICATIONS

This is a national stage application filed under 37 U.S.C. 371 of International Patent Application No. PCT/CN2022/073520, filed Jan. 24, 2022, which claims priority to Chinese Patent Application No. “202110169601.5”, filed on Feb. 7, 2021 and entitled “METHOD AND APPARATUS FOR GENERATING LIGHTING IMAGE, DEVICE, AND MEDIUM”, the disclosures of which are incorporated herein by reference in their entireties.

### TECHNICAL FIELD

The present disclosure relates to the technical field of image processing, in particular to a method and apparatus for generating a lighting image, a device, and a medium.

### BACKGROUND

During game development, by adding different real-time light sources into a game space, a display effect of a scene image of the game space can be improved, for example, the reality of a game scene can be increased.

At present, the number of real-time light sources supported to be added in the game space is very limited, for example, usually, only 2-3 real-time light sources are supported, which cannot satisfy a game scene where a large number of point light sources are required. Moreover, during image rendering, the more the added real-time light sources are, the more resources an electronic device consume, which results in a significant decrease in the performance of the electronic device. Even if a delayed rendering strategy is adopted, the complexity of delayed rendering is proportional to a product of the number of image pixels and the number of the light sources, and the computational complexity is still very high.

### SUMMARY

Embodiments of the present disclosure provide a method and apparatus for generating a lighting image, a device, and a medium.

In a first aspect, an embodiment of the present disclosure provides a method for generating a lighting image, including:
establishing a plurality of Graphics Processing Unit (GPU) particles in a virtual space;
acquiring a position of each GPU particle in the virtual space, and drawing, at the position of each GPU particle, a particle model for representing a lighting area;
determining a positional relationship between each particle model and an illuminated object in the virtual space;
selecting a plurality of target particle models satisfying a lighting requirement from the plurality of particle models based on the positional relationship, and determining a lighting range corresponding to each target particle model;
rendering each target particle model according to the lighting range corresponding to each target particle model to obtain a virtual lighting range image; and
fusing the virtual lighting range image with a scene image corresponding to the illuminated object to obtain a lighting image in the virtual space.

In a second aspect, an embodiment of the present disclosure provides an electronic device, including a memory and a processor, wherein the memory having stored thereon a computer program which, when executed by the processor, enables the processor to perform any method for generating the lighting image according to the embodiment of the present disclosure.

In a third aspect, an embodiment of the present disclosure provides a computer-readable storage medium, having stored thereon a computer program which, when executed by a processor, enables the processor to perform any method for generating the lighting image according to the embodiment of the present disclosure.

### BRIEF DESCRIPTION OF DRAWINGS

The accompanying drawings, which are incorporated in and constitute a part of this description, illustrate embodiments consistent with the present disclosure and serve to explain the principle of the present disclosure together with the description.

To describe the technical solutions in the embodiments of the present disclosure or the prior art more clearly, the accompanying drawings required for describing the embodiments or the prior art will be briefly introduced below. Obviously, those of ordinary skill in the art may still derive other accompanying drawings from these accompanying drawings without creative efforts.

FIG. 1 is a flow chart of a method for generating a lighting image according to an embodiment of the present disclosure;

FIG. 2 is a schematic diagram of particle models drawn based on positions of GPU particles according to an embodiment of the present disclosure;

FIG. 3 is a schematic diagram of virtual point light sources in a virtual space according to an embodiment of the present disclosure;

FIG. 4 is a schematic diagram of a virtual lighting range image according to an embodiment of the present disclosure;

FIG. 5 is a flow chart of another method for generating a lighting image according to an embodiment of the present disclosure;

FIG. 6 is a flow chart of further method for generating a lighting image according to an embodiment of the present disclosure;

FIG. 7 is a schematic structural diagram of an apparatus for generating a lighting image according to an embodiment of the present disclosure; and

FIG. 8 is a schematic structural diagram of an electronic device according to an embodiment of the present disclosure.

### DESCRIPTION OF EMBODIMENTS

In order to understand the above-mentioned objectives, features and advantages of the present disclosure more clearly, the solutions in the present disclosure are to be further described as follows. It should be noted that the embodiments in the present disclosure and features in the embodiments may be combined with each other without conflicts.

In the following description, a number of concrete details have been described to facilitate sufficiently understanding the present disclosure. However, the present disclosure can also be implemented in other ways different from the way described herein. Obviously, the embodiments in the description are only a part of the embodiments of the present disclosure, not all the embodiments.

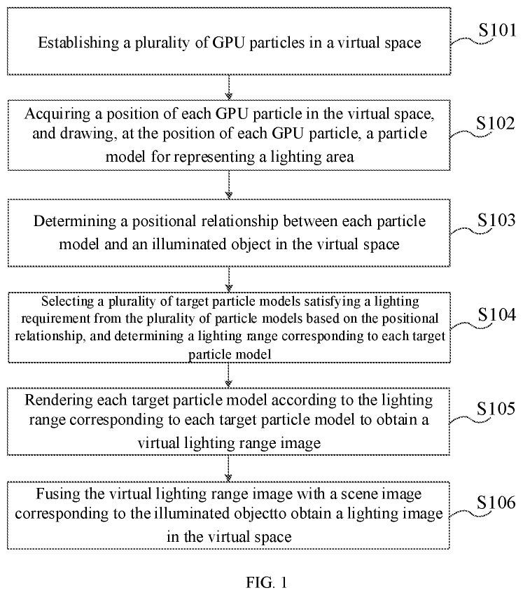

FIG. 1 is a flow chart of a method for generating a lighting image according to an embodiment of the present disclosure, and the embodiment of the present disclosure is applicable to a virtual scene, such as a scene where fireflies flutter and a scene where fireworks are shown all over the sky, where a large number of point light sources are required and there is an illuminated object in the virtual scene. The method may be performed by an apparatus for generating a lighting image, and the apparatus may be implemented by adopting software and/or hardware and may be integrated into any electronic device with computing capacity, such as a smart mobile terminal and a tablet computer.

As shown in FIG. 1, the method for generating the lighting image according to the embodiment of the present disclosure may include the followings.

At S101, a plurality of Graphics Processing Unit (GPU) particles are established in a virtual space.

In the embodiment of the present disclosure, the virtual space may include any scene space having a requirement for displaying a large number of point light sources, such as a virtual space in a game and a virtual space in an animation. For different scene requirements, when it is determined that there is a requirement for displaying a large number of point light sources, for example, during game running or animation production, a large number of point light sources are required to be displayed to illuminate a picture of an illuminated object, the electronic device may randomly establish a plurality of GPU (Graphics Processing Unit) particles in a virtual space. Exemplarily, the electronic device may randomly establish a plurality of GPU particles, or establish a plurality of predetermined GPU particles based on pre-configured particle parameters, which is not specifically limited in the embodiment of the present disclosure. The particle parameters may include, but are not limited to shapes, colors, initial positions, and parameters (such as a movement speed and a movement direction) varying with time, of the GPU particles. Positions of the GPU particles in the virtual space serve as positions of subsequent virtual point light sources, that is, the GPU particles serve as carriers of the virtual point light sources. Moreover, movement states of the virtual point light sources are kept consistent with movement states of the GPU particles in the virtual space, that is, an effect of simulating a large number of point light sources whose positions vary continuously to illuminate a virtual scene can be achieved in the embodiment of the present disclosure. The GPU particles can be used to rapidly draw any object and can increase the processing efficiency for the simulated point light sources.

With a virtual space in a game as an example, after the game is developed and launched, the electronic device may call a game scene monitoring program to monitor each game scene during game running to determine whether each game scene is required to be illuminated by a large number of point light sources, and in a case that it is determined that the game scene is required to be illuminated by the large number of point light sources, a plurality of GPU particles are established in the virtual space of the game, thereby laying the foundation for the subsequent simulation of the large number of virtual point light sources.

At S102, a position of each GPU particle in the virtual space is acquired, and a particle model for representing a lighting area is drawn at the position of each GPU particle.

It should be noted that the virtual space is a three-dimensional virtual space, a two-dimensional picture is finally displayed on the electronic device, and therefore, the particle model may also be drawn by adopting a two-dimensional predetermined shape on the basis that an interface display effect of the virtual scene is not affected, and the predetermined shape may be any geometrical shape, for example, a regular graphic such as a square and a round. A geometric center of the particle model overlaps with a geometric center of the GPU particle.

In an optional implementation, preferably, the particle model may include a two-dimensional square (or referred to as a square patch). The particle model drawn by adopting the two-dimensional square is simple in graphics, is beneficial to the increase of the drawing efficiency, and also relatively conforms to actual lighting areas of the point light sources. After the particle model for representing the lighting area is drawn at the position of each GPU particle, the method for generating the lighting image in the embodiment of the present disclosure further includes: the position of each particle model is adjusted so that a boundary of the particle model whose position is adjusted is parallel to a boundary of the scene image corresponding to the illuminated object.

The scene image in the virtual space is acquired from a shooting perspective of a camera in the virtual space. The position of each particle model is adjusted, which means that each particle model is rotated to a direction facing the camera in the virtual space, and finally, each particle model faces the camera in the virtual space forward. By adjusting the position of the particle model, directions in which the particle models are oriented in a three-dimensional virtual space can be unified, it is ensured that all the virtual point light sources obtained by simulation face the camera in the virtual space forward, and thus, it is ensured that a high-quality interface effect that the virtual scene is illuminated by the point light sources is shown.

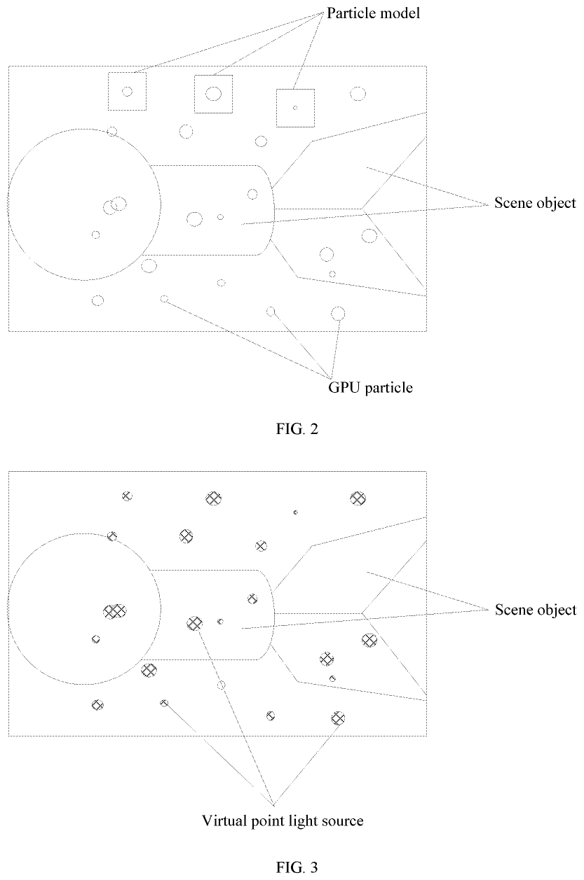

FIG. 2 is a schematic diagram of particle models drawn based on positions of GPU particles according to an embodiment of the present disclosure. Specifically, the embodiment of the present disclosure will be exemplarily described with the two-dimensional square with an example which should not be understood as a specific limitation on the embodiment of the present disclosure. Moreover, FIG. 2 shows the particle models drawn based on positions of parts of the GPU particles, and it should be understood that a plurality of particle models may also be drawn for respective remaining GPU particles. Scene objects shown in FIG. 2 also serve as examples of the illuminated object and may be specifically determined according to the illuminated object required to be displayed in the virtual space.

At S103, a positional relationship between each particle model and an illuminated object in the virtual space is determined.

Exemplarily, the positional relationship between each particle model and the illuminated object may be determined based on positions of the particle model and the illuminated object relative to a same reference object in the virtual space. The reference object may be reasonably set, for example, the camera in the virtual space may serve as the reference object.

At S104, a plurality of target particle models satisfying a lighting requirement are selected from the plurality of particle models based on the positional relationship, and a lighting range corresponding to each target particle model is determined.

The positional relationship between each particle model and an illuminated object in the virtual space may be used to select particle models shielded by the illuminated object and particle models not shielded by the illuminated object (i.e. target particle models satisfying a lighting requirement). Exemplarily, from an observation perspective of the camera in the virtual space, the positional relationship between each particle model and the illuminated object may include: the particle models are located in front of the illuminated object, and the particle models are located at the rear of the illuminated object, wherein the particle models located in front of the illuminated object may serve as the target particle models satisfying the lighting requirement. Moreover, the larger a distance from each target particle model to the illuminated object, the smaller the lighting range corresponding to the target particle model; the smaller the distance from each target particle model to the illuminated object, the larger the lighting range corresponding to the target particle model, and thus, an effect that the brightness of the point light sources gradually far away from the illuminated object gradually decreases can be shown.

At S105, each target particle model is rendered according to the lighting range corresponding to each target particle model to obtain a virtual lighting range image.

Each target particle model determining the lighting range may serve as a virtual point light source. In a process that the virtual lighting range image is obtained, each target particle model may be rendered according to the lighting range corresponding to each target particle model and a distribution requirement (specifically decided by a virtual scene) of the virtual point light sources in the virtual space. The virtual lighting range image obtained by rendering may include, but is not limited to a black-and-white image, that is, colors of the virtual point light sources include, but are not limited to white, which may be reasonably set according to a display requirement, and are not specifically limited in the embodiment of the present disclosure.

As an example, FIG. 3 shows a schematic diagram of virtual point light sources in a virtual space according to an embodiment of the present disclosure, and should not be understood as a specific limitation on the embodiment of the present disclosure. As shown in FIG. 3, round patterns filled with lines shown in FIG. 3 represent the virtual point light sources, and the remaining scene objects serve as examples of the illuminated object in the virtual space.

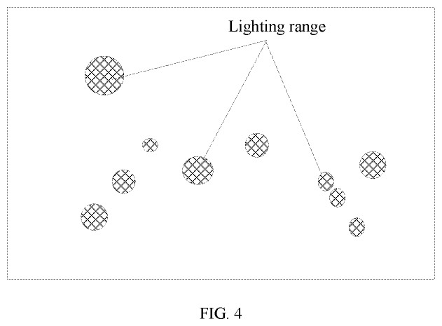

FIG. 4 is a schematic diagram of a virtual lighting range image according to an embodiment of the present disclosure and is used to exemplarily describe the embodiment of the present disclosure. As shown in FIG. 4, the virtual lighting range image is obtained by rendering parts of the virtual point light sources in FIG. 3. FIG. 4 is based on an example in which the virtual lighting range image is a black-and-white image, round patterns filled with lines shown in FIG. 4 represent lighting ranges of the virtual point light sources, and the remaining areas serve as a black background.

At S106, the virtual lighting range image is fused with a scene image corresponding to the illuminated object to obtain a lighting image in the virtual space.

The virtual point light sources are not real point light sources in the virtual space, and therefore, the virtual point light sources cannot be directly rendered into a final picture in the virtual space, and it is necessary to firstly obtain the virtual lighting range image by rendering, and then, fuse the virtual lighting range image with the scene image corresponding to the illuminated object to obtain the lighting image (such as a game interface effect which can be finally shown during game running) in the virtual space. A principle for implementing image fusion may refer to the prior art, and is not specifically limited in the embodiment of the present disclosure.

Optionally, the step that the virtual lighting range image is fused with a scene image corresponding to the illuminated object to obtain a lighting image in the virtual space includes the followings.

A target light source color and a target scene color are acquired, wherein the target light source color is a color of a point light source required in a virtual space in a virtual scene, for example, the target light source color in the scene where fireflies flutter is yellow; and the target scene color is an environment color or background color of the virtual space in the virtual scene and may be specifically determined according to a specific display requirement of the virtual scene, and exemplarily, with the virtual space in the game as an example, the target scene color may be dark blue and may be used to represent a virtual scene such as night.

Interpolation processing is performed on the target light source color and the target scene color by using a target channel value of the virtual lighting range image to obtain an interpolation processing result, wherein the target channel value of the virtual lighting range image may be any channel value, such as an R channel value or a G channel value or a B channel value (the effects of the three channel values are equivalent), relevant to color information of the virtual lighting range image; and the interpolation processing may include, but is not limited to linear interpolation processing.

The interpolation processing result is superimposed with a color value of the scene image corresponding to the illuminated object to obtain the lighting image in the virtual space.

For example, for the scene where fireflies flutter, the lighting image in the virtual space may be an image showing that fireflies with yellow light flutter and any scene object is illuminated.

By performing interpolation processing on the target light source color and the target scene color by using the target channel value of the virtual lighting range image, the smooth transition between the target light source color and the target scene color on the final lighting image can be guaranteed; and then, the interpolation processing result is superimposed with the color value of the scene image in the virtual space, so that the target lighting image in the virtual space shows a high-quality visual effect.

According to the technical solutions in the embodiments of the present disclosure, firstly, the particle models are drawn based on the positions of the GPU particles, then, the particle models are selected according to the positional relationship between each particle model and the illuminated object in the virtual space, and finally, the virtual point light sources are generated based on the selected target particle models, so that an effect of illuminating a virtual scene by a large number of point light sources can be achieved without really increasing real-time point light sources in the virtual space, the display reality of the virtual point light sources is further guaranteed. The computational complexity of the electronic device cannot be increased, excessive consumption of resources of the device can be avoided, and then, performance of the device cannot be excessively affected, while the virtual scene where the large number of point light sources are required is satisfied. With a virtual space in a game as an example, when achieving the purpose of illuminating the illuminated object in the virtual space by using a large number of virtual point light sources, the present solution cannot affect the running of the game, and solves the problems that an existing solution about the addition of light sources cannot satisfy the virtual scene where the large number of point light sources are required and the computational complexity is increased with the increase of the light sources. The technical solutions in the embodiments of the present disclosure can achieve an effect of compatibility with an electronic device with various performances due to no excessive occupation resources of the device, can run in real time on the electronic device, and can optimize an interface display effect of a virtual scene on the electronic device with any performance based on the large number of virtual point light sources.

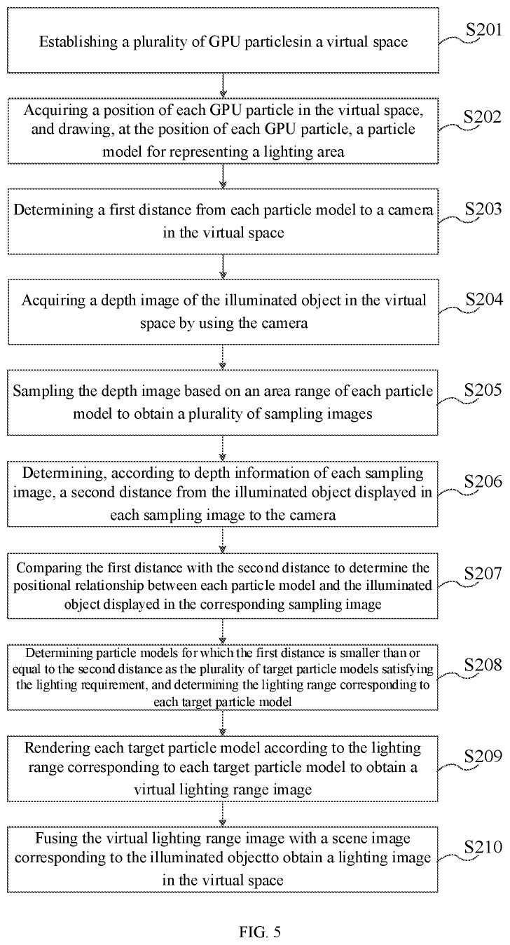

FIG. 5 is a flow chart of another method for generating a lighting image according to an embodiment of the present disclosure. The method is further optimized and expanded based on the above-mentioned technical solutions and may be combined with each of the above-mentioned optional implementations.

As shown in FIG. 5, the method for generating the lighting image according to the embodiment of the present disclosure may include the followings.

At S201, a plurality of GPU particles are established in a virtual space.

At S202, a position of each GPU particle in the virtual space is acquired, and a particle model for representing a lighting area is drawn at the position of each GPU particle.

At S203, a first distance from each particle model to a camera in the virtual space is determined.

Exemplarily, a distance from each pixel point on each particle model to the camera in the virtual space may be determined according to a transformation relationship between a coordinate system of each particle model (i.e. a coordinate system of the particle model itself) and a coordinate system of a display interface (i.e. a coordinate system of a screen of a device), and the first distance from each particle model to the camera in the virtual space may be comprehensively determined (for example, averaged) according to the distance from each pixel point to the camera in the virtual space.

Optionally, the step that a first distance from each particle model to a camera in the virtual space is determined includes the followings.

Interface coordinates of a target reference point in each particle model are determined according to a transformation relationship between a coordinate system of each particle model and a coordinate system of a display interface, wherein the target reference point in each particle model may include, but is not limited to a central point of each particle model.

The first distance from each particle model to the camera in the virtual space is calculated based on the interface coordinates of the target reference point in each particle model.

The above-mentioned transformation relationship between the coordinate system of each particle model and the coordinate system of the display interface may be represented by a coordinate transformation matrix which may be implemented with reference to an existing coordinate transformation principle.

Moreover, for a case that a boundary of the particle model whose position is adjusted is parallel to a boundary of the scene image in the virtual space, each pixel point on the particle model faces the camera in the virtual space, and therefore, distances from all the pixel points on the particle model to the camera in the virtual space are the same. By calculating the first distance from the central point of each particle model to the camera in the virtual space, it may be determined whether the particle model is shielded as a whole; in a case that the particle model is shielded, the particle model disappears as a whole; and in a case that the particle model is not shielded, the particle model appears as a whole, and there is no situation that a part of the particle model is only shielded.

At S204, a depth image of the illuminated object in the virtual space is acquired by using the camera.

The depth image is also referred to as a range image and refers to an image taking a distance (depth) from an image acquisition apparatus to each point in a shooting scene as a pixel value. Therefore, distance information of the illuminated object relative to the camera in the virtual space is recorded in the depth image acquired by the camera in the virtual space.

At S205, the depth image is sampled based on an area range of each particle model to obtain a plurality of sampling images.

Exemplarily, the depth image may be projected from an observation perspective of the camera in the virtual space based on an area range of each particle model to obtain a plurality of sampling images.

At S206, a second distance from the illuminated object displayed in each sampling image to the camera is determined according to depth information of each sampling image.

At S207, the first distance is compared with the second distance to determine the positional relationship between each particle model and the illuminated object displayed in the corresponding sampling image.

In a case that the first distance is larger than the second distance, the corresponding particle model is located at the rear of the illuminated object displayed in the corresponding sampling image; in a case that the first distance is smaller than the second distance, the corresponding particle model is located in front of the illuminated object displayed in the corresponding sampling image; and in a case that the first distance is equal to the second distance, the position of the corresponding particle model overlaps with the position of the illuminated object in a corresponding sampling space.

At S208, particle models for which the first distance is smaller than or equal to the second distance are determined as the plurality of target particle models satisfying the lighting requirement, and the lighting range corresponding to each target particle model is determined.

Optionally, in the process that the plurality of target particle models are determined, the method further includes: pixels of a particle model for which the first distance is larger than the second distance are deleted. That is, the particle models in front of the illuminated object are only displayed, the particle models at the rear of the illuminated object are not displayed, and thus, pixels of particle models not satisfying the lighting requirement are prevented from affecting the display effect of the lighting image in the virtual space.

At S209, each target particle model is rendered according to the lighting range corresponding to each target particle model to obtain a virtual lighting range image.

At S210, the virtual lighting range image is fused with a scene image corresponding to the illuminated object to obtain a lighting image in the virtual space.

According to the technical solutions in the embodiments of the present disclosure, an effect of simulating the virtual point light sources based on the GPU particles is achieved without really increasing and rendering real-time point light sources in the virtual space. The computational complexity of the electronic device cannot be increased, excessive consumption of resources of the device can be avoided, then, performance of the device cannot be excessively affected, while the virtual scene where the large number of point light sources are required is satisfied. The problems that an existing solution about the addition of light sources cannot satisfy the virtual scene where the large number of point light sources are required and the computational complexity is increased with the increase of the light sources are solved. Moreover, the technical solutions in the embodiments of the present disclosure can achieve an effect of compatibility with an electronic device with various performances due to no excessive occupation of resources of the device, can run in real time on the electronic device, and can optimize an interface display effect of a virtual scene on the electronic device with any performance based on the large number of virtual point light sources.

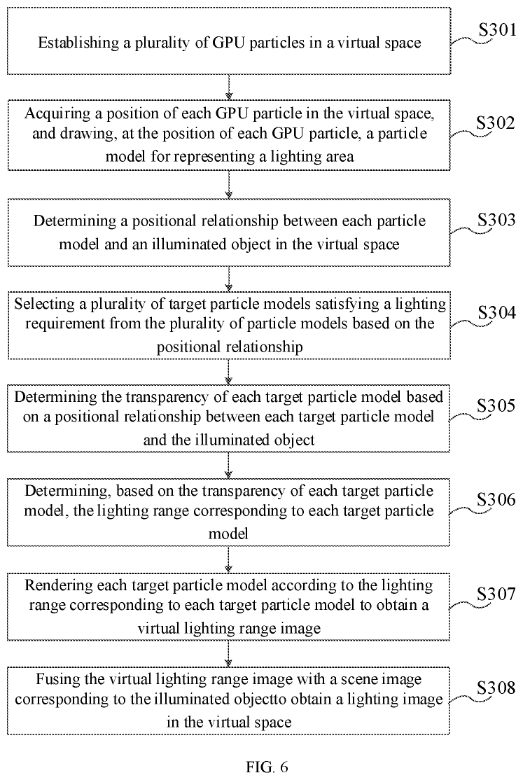

FIG. 6 is a flow chart of further method for generating a lighting image according to an embodiment of the present disclosure. The method is further optimized and expanded based on the above-mentioned technical solutions and may be combined with each of the above-mentioned optional implementations.

As shown in FIG. 6, the method for generating the lighting image according to the embodiment of the present disclosure may include the followings.

At S301, a plurality of GPU particles are established in a virtual space.

At S302, a position of each GPU particle in the virtual space is acquired, and a particle model for representing a lighting area is drawn at the position of each GPU particle.

At S303, a positional relationship between each particle model and an illuminated object in the virtual space is determined.

At S304, a plurality of target particle models satisfying a lighting requirement are selected from the plurality of particle models based on the positional relationship.

At S305, the transparency of each target particle model is determined based on a positional relationship between each target particle model and the illuminated object.

The smaller a relative position distance from the target particle model to the illuminated object in the virtual space, the lower the transparency of the target particle model, and the larger the relative position distance from the target particle model to the illuminated object in the virtual space, the higher the transparency of the target particle model; and in a case that the relative position distance exceeds a distance threshold (the specific value thereof may be flexibly set), the target particle model may be displayed as a disappearing effect, so that the reality that the illuminated object in the virtual space is illuminated by the large number of virtual point light sources can be greatly improved, and the interface display effect is further optimized.

Optionally, the step that the transparency of each target particle model is determined based on a positional relationship between each target particle model and the illuminated object includes the followings.

A target distance from each target particle model to the illuminated object is determined.

The transparency of each target particle model is determined based on the target distance, a transparency change rate, and a predetermined transparency parameter value.

Exemplarily, the target distance from each target particle model to the illuminated object may be determined according to a distance from each target particle model to the camera in the virtual space and a distance from the illuminated object in the virtual space to the camera; and then, the transparency of each target particle model may be determined based on a predetermined computational formula for the target distance, the transparency change rate, and the predetermined transparency parameter value, and the predetermined computational formula may be reasonably designed and is not specifically limited in the embodiments of the present disclosure.

Further, the step that the transparency of each target particle model is determined based on the target distance, a transparency change rate, and a predetermined transparency parameter value includes the followings.

A product of the target distance and the transparency change rate is determined.

The transparency of each target particle model is determined based on a difference between the predetermined transparency parameter value and the product.

The predetermined transparency parameter value may be determined as required. Exemplarily, taking the predetermined transparency parameter value being 1 as an example, at the moment, the transparency value being 1 represents that the target particle model is completely untransparent, and the transparency value being 0 represents that the target particle model is completely transparent. The transparency color.alpha of the target particle model may be expressed by the following formula:

color.alpha=1−|depth−i.eye.z|·IntersectionPower

wherein |depth−i.eye.z| represents the target distance from each target particle model to the illuminated object in the virtual space, i.eye.z represents the first distance from each target particle model to the camera in the virtual space, depth represents the second distance from the illuminated object displayed in each sampling image to the camera in the virtual space, IntersectionPower represents the transparency change rate, and a value thereof may also be adaptively set.

At S306, a lighting range corresponding to each target particle model is determined based on the transparency of each target particle model.

The smaller a relative position distance from the target particle model to the illuminated object in the virtual space, the lower the transparency of the target particle model, and the larger the relative position distance from the target particle model to the illuminated object in the virtual space, the higher the transparency of the target particle model, and the smaller the lighting range. The lighting range corresponding to each target particle model may be determined by adopting any available way based on a relationship between the above-mentioned transparency and the lighting range.

Optionally, the step that the lighting range corresponding to each target particle model is determined based on the transparency of each target particle model includes the followings.

A map with a predetermined shape is generated for each target particle model, wherein a middle area of the map is white, remaining areas other than the middle area are black, and the map may be round, which relatively conforms to actual lighting effects of the point light sources.

A product of a target channel value of the map and the transparency of each target particle model is determined as a final transparency of each target particle model.

The lighting range corresponding to each target particle model is determined based on the final transparency of each target particle model.

Each target particle model determining the lighting range may serve as a virtual point light source. The target channel value of the map of each target particle model may be any channel value, such as an R channel value or a G channel value or a B channel value, relevant to color information of the map, the effects of the three channel values are equivalent, multiplying any channel value by the transparency of the target particle model will not affect the finally obtained circular virtual point light sources that are untransparent in middles and transparent around. Moreover, an effect that pixels far from the illuminated object are more transparent and pixels close to the illuminated object are more untransparent can be shown on the obtained circular virtual point light sources, and thus, an ideal effect of illuminating the point light sources in a surrounding spherical area is shown.

At S307, each target particle model is rendered according to the lighting range corresponding to each target particle model to obtain a virtual lighting range image.

At S308, the virtual lighting range image is fused with a scene image corresponding to the illuminated object to obtain a lighting image in the virtual space.

According to the technical solutions in the embodiments of the present disclosure, an effect of simulating the virtual point light sources based on the GPU particles is achieved without really increasing and rendering real-time point light sources in the virtual space. The computational complexity of the electronic device cannot be increased, excessive consumption of resources of the device can be avoided, then, performance of the device cannot be excessively affected, while the virtual scene where the large number of point light sources are required is satisfied. The problems that an existing solution about the addition of light sources cannot satisfy the virtual scene where the large number of point light sources are required and the computational complexity is increased with the increase of the light sources are solved. Moreover, the transparency of each target particle model is determined based on the positional relationship between each target particle model and the illuminated object, and the lighting range corresponding to each target particle model is determined based on the transparency of each target particle model, so that the reality that the illuminated object in the virtual space is illuminated by the large number of virtual point light sources is improved, and the interface display effect of the virtual scene on the electronic device is optimized.

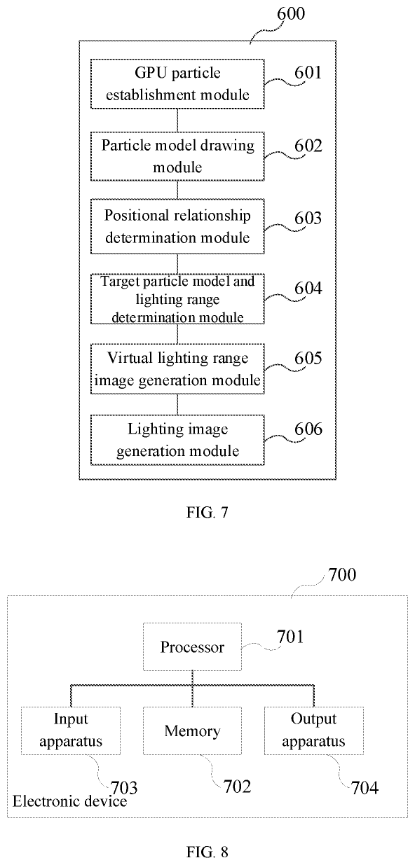

FIG. 7 is a schematic structural diagram of an apparatus for generating a lighting image according to an embodiment of the present disclosure, and the embodiment of the present disclosure is applicable to a virtual scene where a large number of point light sources are required and there is an illuminated object in the virtual scene. The apparatus may be implemented by adopting software and/or hardware and may be integrated into any electronic device with computing capacity, such as a smart mobile terminal and a tablet computer.

As shown in FIG. 7, the apparatus 600 for generating the lighting image according to the embodiment of the present disclosure may include a Graphics Processing Unit (GPU) particle establishment module 601, a particle model drawing module 602, a positional relationship determination module 603, a target particle model and lighting range determination module 604, a virtual lighting range image generation module 605, and a lighting image generation module 606.

The GPU particle establishment module 601 is configured to establish a plurality of GPU particles in a virtual space.

The particle model drawing module 602 is configured to acquire a position of each GPU particle in the virtual space, and draw, at the position of each GPU particle, a particle model for representing a lighting area.

The positional relationship determination module 603 is configured to determine a positional relationship between each particle model and an illuminated object in the virtual space.

The target particle model and lighting range determination module 604 is configured to select a plurality of target particle models satisfying a lighting requirement from the plurality of particle models based on the positional relationship, and determine a lighting range corresponding to each target particle model.

The virtual lighting range image generation module 605 is configured to render each target particle model according to the lighting range corresponding to each target particle model to obtain a virtual lighting range image; and

The lighting image generation module 606 is configured to fuse the virtual lighting range image with a scene image corresponding to the illuminated object to obtain a lighting image in the virtual space.

Optionally, the positional relationship determination module 603 includes:
a first distance determination unit configured to determine a first distance from each particle model to a camera in the virtual space;
a depth image acquisition unit configured to acquire a depth image of the illuminated object in the virtual space by using the camera;
a sampling image determination unit configured to sample the depth image based on an area range of each particle model to obtain a plurality of sampling images;
a second distance determination unit configured to determine, according to depth information of each sampling image, a second distance from the illuminated object displayed in each sampling image to the camera; and
a positional relationship determination unit configured to compare the first distance with the second distance to determine the positional relationship between each particle model and the illuminated object displayed in the corresponding sampling image.

The target particle model and lighting range determination module 604 includes:
a target particle model determination unit configured to select a plurality of target particle models satisfying a lighting requirement from the plurality of particle models based on the positional relationship; and
a lighting range determination unit configured to determine a lighting range corresponding to each target particle model.

The target particle model determination unit is specifically configured to determine particle models for which the first distance is smaller than or equal to the second distance as the plurality of target particle models satisfying the lighting requirement.

Optionally, the first distance determination unit includes:
an interface coordinate determination subunit configured to determine interface coordinates of a target reference point in each particle model according to a transformation relationship between a coordinate system of each particle model and a coordinate system of a display interface; and
a first distance calculation subunit configured to calculate the first distance from each particle model to the camera in the virtual space based on the interface coordinates of the target reference point in each particle model.

Optionally, the target particle model determination unit is further configured to:
delete pixels of a particle model for which the first distance is larger than the second distance.

Optionally, the lighting range determination unit includes:
a transparency determination subunit configured to determine the transparency of each target particle model based on a positional relationship between each target particle model and the illuminated object; and
a lighting range determination subunit configured to determine, based on the transparency of each target particle model, the lighting range corresponding to each target particle model.

Optionally, the transparency determination subunit includes:
a target distance determination subunit configured to determine a target distance from each target particle model to the illuminated object; and
a transparency calculation subunit configured to determine the transparency of each target particle model based on the target distance, a transparency change rate, and a predetermined transparency parameter value.

Optionally, the transparency calculation subunit includes:
a first determination subunit configured to determine a product of the target distance and the transparency change rate; and
a second determination subunit configured to determine the transparency of each target particle model based on a difference between the predetermined transparency parameter value and the product.

Optionally, the lighting range determination subunit includes:
a map generation subunit configured to generate a map with a predetermined shape for each target particle model, wherein a middle area of the map is white, and remaining areas other than the middle area are black;
a third determination subunit configured to determine a product of a target channel value of the map and the transparency of each target particle model as a final transparency of each target particle model; and
a fourth determination subunit configured to determine, based on the final transparency of each target particle model, the lighting range corresponding to each target particle model.

Optionally, the lighting image generation module 606 includes:
a color acquisition unit configured to acquire a target light source color and a target scene color;
an interpolation processing unit configured to perform interpolation processing on the target light source color and the target scene color by using a target channel value of the virtual lighting range image to obtain an interpolation processing result; and
a lighting image generation unit configured to superimpose the interpolation processing result with a color value of the scene image corresponding to the illuminated object to obtain the lighting image in the virtual space.

Optionally, the particle models include two-dimensional squares, and the apparatus for generating the lighting image according to the embodiment of the present disclosure further includes:
a particle model position adjustment module configured to adjust the position of each particle model so that a boundary of the particle model whose position is adjusted is parallel to a boundary of the scene image corresponding to the illuminated object.

The apparatus for generating the lighting image according to the embodiment of the present disclosure may be used to perform the method for generating the lighting image according to the embodiment of the present disclosure and has the corresponding functional modules and beneficial effects as the method is performed. Contents that are not described in detail in the apparatus embodiment of the present disclosure may refer to the description in any method embodiment of the present disclosure.

FIG. 8 is a schematic structural diagram of an electronic device according to an embodiment of the present disclosure and is used to exemplarily describe the electronic device for implementing the method for generating the lighting image in the embodiment of the present disclosure. The electronic device may include, but is not limited to a smart mobile terminal and a tablet computer. As shown in FIG. 8, the electronic device 700 includes one or more processors 701 and a memory 702.

The processor 701 may be a central processing unit (CPU) or processing units in other forms, which have data processing and/or instruction execution capability, and can control other components in the electronic device 700 to execute desired functions.

The memory 702 may include one or more computer program products which may include computer-readable storage media in various forms, such as a volatile memory and/or a non-volatile memory. The volatile memory may include, for example, a random access memory (RAM) and/or a cache. The non-volatile memory may include, for example, a read-only memory (ROM), a hard disk, and a flash memory. One or more computer program instructions may be stored on a computer-readable storage medium, and the processor 701 enables the program instructions to run to implement any method for generating the lighting image according to the embodiment of the present disclosure and other desired functions. Various contents, such as an input signal, a signal component, and a noise component, may be further stored in the computer-readable storage medium.

In an example, the electronic device 700 may further include an input apparatus 703 and an output apparatus 704, and these components are interconnected by a bus system and/or connecting mechanisms in other forms (not shown).

In addition, the input apparatus 703 may further include, for example, a keyboard and a mouse.

The output apparatus 704 may output various information, including determined distance information, direction information, etc. to the outside. The output apparatus 704 may include, for example, a display, a loudspeaker, a printer, a communication network, and a remote output device connected thereto.

Of course, for simplicity, FIG. 8 only shows some of components, relevant to the present disclosure, in the electronic device 700, omits components such as a bus and an input/output interface. In addition, according to a specific application, the electronic device 700 may further include any other appropriate components.

In addition to the above-mentioned method and device, an embodiment of the present disclosure may further provide a computer program product including a computer program instruction, and the computer program instruction, when executed by a processor, enables the processor to perform any method for generating the lighting image according to the embodiment of the present disclosure.

The computer program product may compile, by one or any combinations of various programming languages, program codes used to perform the operations in the embodiments of the present disclosure, and the programming languages include object-oriented programming languages, such as Java and C++, and further include conventional procedural programming languages, such as “C” languages or similar programming languages. The program codes may be completely executed on an electronic device of a user, partially executed on a user device, executed as an independent software package, partially executed on the electronic device of the user and partially executed on a remote electronic device, or completely executed on the remote electronic device or a server.

In addition, an embodiment of the present disclosure may further provide a computer-readable storage medium having stored thereon a computer program instruction, and the computer program instruction, when executed by a processor, enables the processor to perform any method for generating the lighting image according to the embodiment of the present disclosure.

The computer-readable storage medium may adopt one or any appropriate combinations of a plurality of readable media. Each of the readable media may be a readable signal medium or a readable storage medium. The readable storage medium may include, but not limited to electric, magnetic, optical, electromagnetic, infrared or semiconductor system, apparatus or device or any combinations thereof. A more specific example (a non-exhaustive list) of the readable storage medium includes an electric connection, a portable disk, a hard disk, a random access memory (RAM), a read-only memory (ROM), an erasable programmable read-only memory (EPROM or a flash memory), an optical fiber, a portable compact disc read-only memory (CD-ROM), an optical storage device, a magnetic storage device, or any appropriate combinations thereof.

It should be noted that, herein, relational terms such as “first” and “second” are only used to distinguish one entity or operation from another one, but do not necessarily require or imply the presence of any such actual relationship or order between these entities or operations. Moreover, terms “includes”, “including” or any other variants thereof are intended to cover non-excludable inclusion, so that a process, method, article or device including a series of elements not only includes those elements, but also includes other elements not listed clearly, or further includes inherent elements of the process, method, article or device. Under the condition that no more limitations are provided, elements defined by the word “including a . . . ” do not exclude other same elements further existing in the process, method, article or device including the elements.

The above-mentioned descriptions are only specific implementations of the present disclosure and enable those skilled in the art to understand or implement the present disclosure. Various modifications on these embodiments are apparent to those skilled in the art, and general principles defined herein may be implemented in the other embodiments without departing from the spirit or scope of the present disclosure. Thus, the present disclosure is not to be limited to these embodiments of the present disclosure, but shall accord with the widest scope consistent with the principles and novel characteristics disclosed in the present disclosure.

1. A method for generating a lighting image, comprising:
establishing a plurality of Graphics Processing Unit (GPU) particles in a virtual space;
acquiring a position of each GPU particle in the virtual space, and drawing, at the position of each GPU particle, a particle model for representing a lighting area;
determining a positional relationship between each particle model and an illuminated object in the virtual space;
selecting a plurality of target particle models satisfying a lighting requirement from the plurality of particle models based on the positional relationship, and determining a lighting range corresponding to each target particle model;
rendering each target particle model according to the lighting range corresponding to each target particle model to obtain a virtual lighting range image; and
fusing the virtual lighting range image with a scene image corresponding to the illuminated object to obtain a lighting image in the virtual space.

2. The method according to claim 1, wherein the determining a positional relationship between each particle model and an illuminated object in the virtual space comprises:
determining a first distance from each particle model to a camera in the virtual space;
acquiring a depth image of the illuminated object in the virtual space by using the camera;
sampling the depth image based on an area range of each particle model to obtain a plurality of sampling images;
determining, according to depth information of each sampling image, a second distance from the illuminated object displayed in each sampling image to the camera;
comparing the first distance with the second distance, and determining the positional relationship between each particle model and the illuminated object displayed in a corresponding sampling image,
wherein the selecting a plurality of target particle models satisfying a lighting requirement from the plurality of particle models based on the positional relationship comprises:
determining particle models for which the first distance is smaller than or equal to the second distance as the plurality of target particle models satisfying the lighting requirement.

3. The method according to claim 2, wherein the determining a first distance from each particle model to a camera in the virtual space comprises:
determining interface coordinates of a target reference point in each particle model according to a transformation relationship between a coordinate system of each particle model and a coordinate system of a display interface; and
calculating the first distance from each particle model to the camera in the virtual space based on the interface coordinates of the target reference point in each particle model.

4. The method according to claim 2, wherein the selecting a plurality of target particle models satisfying a lighting requirement from the plurality of particle models based on the positional relationship further comprises:
deleting pixels of a particle model for which the first distance is larger than the second distance.

5. The method according to claim 1, wherein the determining a lighting range corresponding to each target particle model comprises:
determining transparency of each target particle model based on a positional relationship between each target particle model and the illuminated object; and
determining, based on the transparency of each target particle model, the lighting range corresponding to each target particle model.

6. The method according to claim 5, wherein the determining the transparency of each target particle model based on a positional relationship between each target particle model and the illuminated object comprises:
determining a target distance from each target particle model and the illuminated object; and
determining the transparency of each target particle model based on the target distance, a transparency change rate, and a predetermined transparency parameter value.

7. The method according to claim 6, wherein the determining the transparency of each target particle model based on the target distance, a transparency change rate, and a predetermined transparency parameter value comprises:
determining a product of the target distance and the transparency change rate; and
determining the transparency of each target particle model based on a difference between the predetermined transparency parameter value and the product.

8. The method according to claim 5, wherein the determining, based on the transparency of each target particle model, the lighting range corresponding to each target particle model comprises:
generating a map with a predetermined shape for each target particle model, wherein a middle area of the map is white, and remaining areas other than the middle area are black;
determining a product of a target channel value of the map and the transparency of each target particle model as a final transparency of each target particle model; and
determining, based on the final transparency of each target particle model, the lighting range corresponding to each target particle model.

9. The method according to claim 1, wherein the fusing the virtual lighting range image with a scene image corresponding to the illuminated object to obtain a lighting image in the virtual space comprises:
acquiring a target light source color and a target scene color;
performing interpolation processing on the target light source color and the target scene color by using a target channel value of the virtual lighting range image to obtain an interpolation processing result; and
superimposing the interpolation processing result with a color value of the scene image corresponding to the illuminated object to obtain the lighting image in the virtual space.

10. The method according to claim 1, wherein the particle models comprise two-dimensional squares, and the method further comprises, after the drawing, at the position of each GPU particle, a particle model for representing a lighting area:
adjusting the position of each particle model so that a boundary of the particle model whose position is adjusted is parallel to a boundary of the scene image corresponding to the illuminated object.

11. (canceled)

12. An electronic device, comprising a memory and a processor, the memory having stored thereon a computer program which, when executed by the processor, enables the processor to perform operations comprising:
establishing a plurality of Graphics Processing Unit (GPU) particles in a virtual space;
acquiring a position of each GPU particle in the virtual space, and drawing, at the position of each GPU particle, a particle model for representing a lighting area;
determining a positional relationship between each particle model and an illuminated object in the virtual space;
selecting a plurality of target particle models satisfying a lighting requirement from the plurality of particle models based on the positional relationship, and determining a lighting range corresponding to each target particle model;
rendering each target particle model according to the lighting range corresponding to each target particle model to obtain a virtual lighting range image; and
fusing the virtual lighting range image with a scene image corresponding to the illuminated object to obtain a lighting image in the virtual space.

13. (canceled)

14. The electronic device according to claim 12, wherein the determining a positional relationship between each particle model and an illuminated object in the virtual space comprises:
determining a first distance from each particle model to a camera in the virtual space;
acquiring a depth image of the illuminated object in the virtual space by using the camera;
sampling the depth image based on an area range of each particle model to obtain a plurality of sampling images;
determining, according to depth information of each sampling image, a second distance from the illuminated object displayed in each sampling image to the camera;
comparing the first distance with the second distance, and determining the positional relationship between each particle model and the illuminated object displayed in a corresponding sampling image,
wherein the selecting a plurality of target particle models satisfying a lighting requirement from the plurality of particle models based on the positional relationship comprises:
determining particle models for which the first distance is smaller than or equal to the second distance as the plurality of target particle models satisfying the lighting requirement.

15. The electronic device according to claim 14, wherein the determining a first distance from each particle model to a camera in the virtual space comprises:
determining interface coordinates of a target reference point in each particle model according to a transformation relationship between a coordinate system of each particle model and a coordinate system of a display interface; and
calculating the first distance from each particle model to the camera in the virtual space based on the interface coordinates of the target reference point in each particle model.

16. The electronic device according to claim 14, wherein the selecting a plurality of target particle models satisfying a lighting requirement from the plurality of particle models based on the positional relationship further comprises:
deleting pixels of a particle model for which the first distance is larger than the second distance.

17. The electronic device according to claim 12, wherein the determining a lighting range corresponding to each target particle model comprises:
determining transparency of each target particle model based on a positional relationship between each target particle model and the illuminated object; and
determining, based on the transparency of each target particle model, the lighting range corresponding to each target particle model.

18. The electronic device according to claim 17, wherein the determining the transparency of each target particle model based on a positional relationship between each target particle model and the illuminated object comprises:
determining a target distance from each target particle model and the illuminated object; and
determining the transparency of each target particle model based on the target distance, a transparency change rate, and a predetermined transparency parameter value.

19. The electronic device according to claim 18, wherein the determining the transparency of each target particle model based on the target distance, a transparency change rate, and a predetermined transparency parameter value comprises:
determining a product of the target distance and the transparency change rate; and
determining the transparency of each target particle model based on a difference between the predetermined transparency parameter value and the product.

20. The electronic device according to claim 17, wherein the determining, based on the transparency of each target particle model, the lighting range corresponding to each target particle model comprises:
generating a map with a predetermined shape for each target particle model, wherein a middle area of the map is white, and remaining areas other than the middle area are black;
determining a product of a target channel value of the map and the transparency of each target particle model as a final transparency of each target particle model; and
determining, based on the final transparency of each target particle model, the lighting range corresponding to each target particle model.

21. The electronic device according to claim 12, wherein the fusing the virtual lighting range image with a scene image corresponding to the illuminated object to obtain a lighting image in the virtual space comprises:
acquiring a target light source color and a target scene color;
performing interpolation processing on the target light source color and the target scene color by using a target channel value of the virtual lighting range image to obtain an interpolation processing result; and
superimposing the interpolation processing result with a color value of the scene image corresponding to the illuminated object to obtain the lighting image in the virtual space.

22. A computer-readable storage medium, having stored thereon a computer program which, when executed by a processor, enables the processor to perform the method for generating the lighting image according to claim 1.
